(19) United States
(12) Patent Application Publication
(10) Pub. No.: US 2022/0138082 A1
(43) Pub. Date: May 5, 2022

(54) Applied Computer Technology for High Efficiency and Scalable Value Stream Mapping

(71) Applicant: Copado, Inc., Chicago, IL (US)

(72) Inventors: Andrew Davis, San Diego, CA (US); Gloria Ramchandani, Alpharetta, GA (US); Mert Yalti, Madrid (ES); Ümit Can Uçkan, Madrid (ES); Mario González Duarte, Madrid (ES)

(21) Appl. No.: 17/576,209

(22) Filed: Jan. 14, 2022

Related U.S. Application Data
(63) Continuation-in-part of application No. 17/376,782, filed on Jul. 15, 2021.
(60) Provisional application No. 63/052,177, filed on Jul. 15, 2020.

(51) Int. Cl. G06F 11/36

(52) U.S. Cl. CPC G06F 11/3616; G06F 3/04847; G06F 11/3608

(57) ABSTRACT

A system for value stream mapping is disclosed, the system comprising a processor and memory. The memory is configured to store a value stream map (VSM) model for a process, the VSM model comprising a sequence of active stages for a plurality of items of the process, wherein each active stage is associated with one or more status values attributable to the items. The processor is configured to (1) access a time series of status change data about items for the process, wherein the status change data comprises a plurality of status values exhibited by the items over time and (ii) transform the accessed time series into a VSM based on a correlation between (i) the status values exhibited by the items from the accessed time series and (ii) the status values associated with the active stages of the VSM model. Corresponding methods and computer program products are also disclosed.

This application is a continuation-in-part of U.S. patent application Ser. No. 17/376,782, filed Jul. 15, 2021, and entitled “Applied Computer Technology for High Efficiency Value Stream Management and Mapping and Process Tracking”, which claims the benefit of U.S. Provisional Patent Application Ser. No. 63/052,177, filed Jul. 15, 2020, and entitled “Methods for Managing Development and Operation Process in a Cloud Environment and Devices Thereof”, the entire disclosures of each of which are hereby incorporated by reference.

### INTRODUCTION

Complex business processes such as software development often require multiple sub-processes performed by different people over a period of hours, days, or weeks. There are often enormous inefficiencies in these processes, with work waiting in queues between sub-processes, work performed in earlier stages not meeting the requirements for later stages, and excessive load causing work to take longer than necessary. These inefficiencies impede business effectiveness, causing additional delays and costs. These work items are usually tracked in a database which may record changes to the state of work items, but which does not provide a way to gather summary metrics across all of the work items.

To clearly understand and address these inefficiencies, teams need a way to visualize the sequence of sub-processes, and to track metrics like duration, quality, completion rates, and load on each sub-process. To accomplish this, businesses need a way to model the sequence of sub-processes involved in their business processes and to calculate metrics about work progress based on that model. Gathering such metrics on process and sub-processes currently require estimates and approximations based on a small sampling of data captured at a particular moment in time because the data required for each sub-process often resides in different systems, is not monitored in real time, and is stored in ways that make it impossible for humans to analyze them accurately.

For example, most systems either do not track change information, or track it as a series of many updates distributed across thousands or millions of records. Those change records include many types of changes, most of which are irrelevant to calculating the metrics of interest. Accordingly, identifying areas of improvement is imprecise, and not updated in real time with manual approaches to value stream mapping, which fail to effectively track and analyze processes over time to facilitate performance optimizations.

In an effort to provide solutions to one or more of these and other shortcomings in the art, the inventors disclose a system for value stream mapping, the system comprising a memory configured to store a value stream map (VSM) model for a process, the VSM model comprising a sequence of active stages for a plurality of items of the process, wherein each active stage is associated with one or more status values attributable to the items. The system further comprises a processor for cooperation with the memory, the processor configured to (1) access a time series of status change data about a plurality of items for the process, wherein the status change data comprises a plurality of status values exhibited by the items over time and (ii) transform the accessed time series of status change data into a VSM based on a correlation between (i) the status values exhibited by the items from the accessed time series of change data and (ii) the status values associated with the active stages of the VSM model. Corresponding methods and computer program products are also disclosed.

The technology disclosed herein efficiently generates VSMs that facilitate more effective analysis of tracked processes represented by the VSMs. With this technology, log data generated by enterprise application platform (e.g., Salesforce™) processes (e.g., software development) can be efficiently processed and analyzed using particular database table and other types of manipulations to generate useful metrics and for the tracked processes. This technology can leverage a mapping of statuses to process blocks within stages of tracked processes, along with correlations to log data representing events and activity associated with the processes, to generate rich VSMs that more effectively illuminate areas of improvement and optimizations for the processes.

The VSM modeling disclosed herein can be customized by users to represent any of a plurality of different processes. Such customization can be achieved by adapting a given VSM model to exhibit different features (and thus fitting the adapted VSM model to a different process) or by defining a plurality of different VSM models for a plurality of different processes to create a library of different VSM models for producing VSMs relating to the different processes. The inventors disclose a variety of graphical user interfaces (GUIs) herein that are designed to receive user input in order to provide flexible customization of VSM models. Through such customization, the technology disclosed herein provides levels of scalability and efficiency that are significant and meaningful improvements over conventional computer systems for generating VSMs because the same platform can serve as a universal tool for generating VSMS for any user-definable process. Conventional computer systems for generating VSMs are not readily adaptable in this manner and thus require significant amounts of re-engineering and re-coding in order to generate VSMs for different processes.

Thus, the technology disclosed herein includes creating a customizable software application that can convert a sequence of changes to database records into a VSM visualization. This VSM application allows users to model a business process, and then use that model to convert a sequence of changes to database records into metrics. The VSM application provides a “drag and drop” user interface for easily defining the processes and sub-processes and correlating those to states of a work items in a database. Users can define custom metrics which should be tracked within the processes and sub-processes. Once configured and activated, the VSM application can deliver historical and real-time metrics on how long it takes to complete work (i.e., duration), how long work waits, the quality of work, and how many work items have been completed over a historical period of time, for example, while facilitate collaborative discussion and filtering to analyze subsets of data.

Thus, as technical innovations in the art, techniques are described and illustrated herein that practically apply computer technology in new and meaningful ways that are able to find the “signal” within the “noise” through exposing database change records that would otherwise be imperceptible or difficult to relate to relevant process models if using conventional computer systems in the art, processing very large numbers (e.g., millions) of these records, filtering only relevant items, correlating the relevant items to a model of a work process, and/or using that model to create a coherent picture of the progress of work associated with the work process.

### BRIEF DESCRIPTION OF THE DRAWINGS

FIG. 1 is a block diagram of an exemplary network environment that includes an enterprise application platform with application servers;

FIG. 2 is a block diagram of an application server hosting a value stream map (VSM) application that facilitates management of tracked processes;

FIG. 3 is a flowchart of an exemplary method for value stream mapping and management of processes tracked in computer systems;

FIG. 4A is a flowchart of an exemplary method for application provisioning to facilitate data collection useful for generating VSMs and associated analytics;

FIG. 4B is a flowchart of an exemplary method for customizing a VSM model to a particular process;

FIG. 4C shows an exemplary sequence of stages and associated process blocks for a VSM model that can be defined in response to user input;

FIG. 5A is an exemplary value stream definition interface;

FIG. 5B is an exemplary interface for defining a sequence of stages for a process to be modeled;

FIGS. 6A-B are exemplary value stream configuration interfaces;

FIG. 6C is an exemplary table that shows how work items exhibiting various status values would be correlated to stages and process flows based on the VSM model mapping of FIG. 6B;

FIG. 7 is an exemplary new metric interface;

FIG. 8 is an exemplary metric configuration interface;

FIG. 9 is an exemplary process block creation interface;

FIG. 10 is a flowchart of an exemplary method for converting change data to a summary of activity useful for generating VSMs and associated analytics;

FIG. 11 is a screenshot of exemplary event records;

FIG. 12 is an exemplary VSM;

FIG. 13 is a screenshot of exemplary value stream management metrics details;

FIG. 14 is a screenshot of exemplary underlying records in a VSM;

FIG. 15 is an exemplary screenshot of an integrated chat application;

FIG. 16 is an exemplary filter interface;

FIG. 17 is exemplary timelines interface; and

FIG. 18 is an exemplary cumulative flow graph.

### DETAILED DESCRIPTION OF EXAMPLE EMBODIMENTS

Enterprise application platforms, such as the Salesforce™ platform, enable developers to create add-on applications that are built on the underlying functionality of the platform. For example, the Salesforce™ platform includes services that are accessible to developers to facilitate development and deployment of add-on applications and websites that are hosted on the Salesforce™ platform and available for use by end users. Enterprise application platforms, including the Salesforce™ platform, can facilitate the generation of logs that are accumulated over time and maintain data associated with processes that are performed on the platform. Some examples of linear processes facilitated by enterprise application platforms are software development, customer support, and sales processes, although the technology described and illustrated herein can leverage other types of processes that may be managed via enterprise application(s).

This technology relates to a system (e.g., in the form of an add-on application that can be hosted on an enterprise application platform) for transforming a time series of log data, generated based on user interactions with an enterprise application as part of a work process, into statistical summaries of the progress of individual work items associated with the work process. The transformation is based on specification of the work being tracked and results in the creation of a visual model of the work process, which is referred to herein as a value stream map (VSM).

This VSM defines the way the log data is filtered and summarized, which is relatively efficient with this technology, and advantageously provides an improved user interface environment that presents the results of an analysis of the log data in a more effective manner so that trends can be tracked and areas for improvement can be identified. In some examples, the statistical summaries, or other statistical or analytical information, is displayed as an overlay on the VSM to allow for more efficient and effective value stream management, tracking process data over time, and optimizing performance of the associated work process.

Accordingly, the VSM of this technology includes a graphical representation of the stages by which work associated with a work process is performed and the metrics associated with that work process. Any type of work can be tracked with this technology, as long as the overall associated work process can be represented by a linear system of serial or parallel steps, and changes to the status of work can be tracked in a linear time series (e.g., via log data as explained in more detail below). As noted above, the ability to customize the VSM modeling to any work process yields a computer system that is highly scalable for generating VSMs with respect to different work processes.

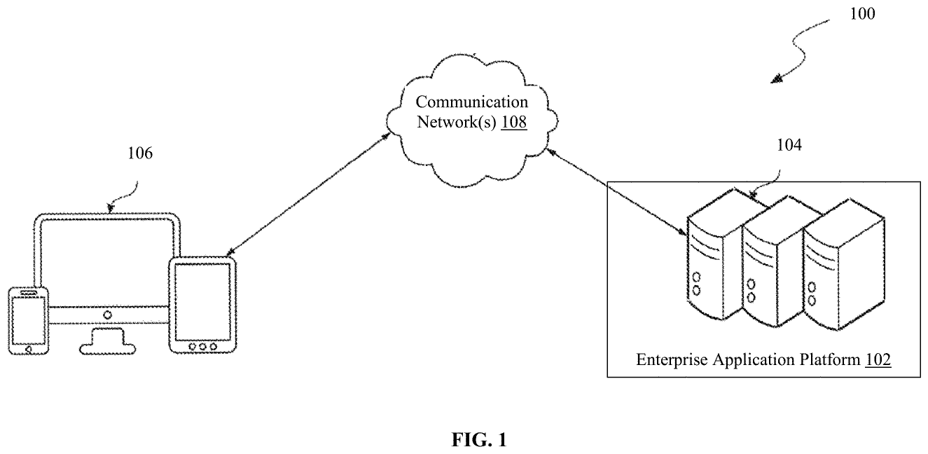

The main body of the VSM is composed of a series of stages, each of which has one or more parallel processes. Each of the process blocks includes metrics indicating the amount of processing and waiting time associated with that process, the number of work items and workers currently active in that process, and the percentage of work leaving that process that is both complete and accurate. The VSM also includes metrics summarizing the amount of time and the percentage of work that moves through the entire business process without being sent back due to quality issues. An exemplary environment for, and an exemplary operation of, this technology will now be described in more detail with reference to FIGS. 1-18.

Referring more specifically to FIG. 1, a block diagram of an exemplary network environment 100 that includes an enterprise application platform 102 with application servers 104 is illustrated. The application servers 104 in this example are coupled to client devices 106 via communication network(s), although the application servers 104 and client devices 106 can be coupled together via other topologies. The network environment 100 also may include other network devices, such as one or more routers or switches, for example, which are known in the art and thus will not be described herein.

In the example network environment 100, service providers can use the enterprise application platform 102 (e.g., the Salesforce™ platform) to provide add-on applications that the client devices 106 can access via the communication network(s) 108. The communication network(s) 108 may include any combination of private, public, wired, or wireless networks. Data communicated over the communication network(s) 108 may be encrypted or unencrypted at various locations or along different portions of the communication network(s) 108. Accordingly, each component depicted in the example network environment 100 may include combinations of hardware and/or software to process data, perform functions, communicate over the communication network(s) 108, and the like.

The enterprise application platform 102 can provide access to a shared pool of configurable computing resources, including servers, storage, applications, a software platform, networks, services, and the like, accessed by service provider servers or other devices (not shown) to offer add-on applications to the client devices 106. The enterprise application platform 102 in this example supports multiple tenants and may be referred to as a platform as a service (PaaS). The enterprise application platform 102 can be accessible to developers for creating the add-on applications that run on the components of the enterprise application platform 102. Developers can include third-party developers that do not own, operate, provide, or otherwise manage the enterprise application platform 102.

For example, the Salesforce™ platform includes a PaaS called Force.com that is accessible to developers to simplify the development and deployment of add-on applications and websites that are hosted on the Salesforce™ platform and available for use by end users of the client devices 106. Such add-on applications can provide services, such as those described and illustrated by way of the examples herein, that are provided by the application servers 104 and are built on the underlying functionality of the enterprise application platform 102. The application servers 104 also may provide or administer a user interface (e.g., website) accessible from the client devices 106 that may include features such as dashboard analytics.

The add-on applications provided by application servers 104 are built using one or more programming languages that are particular to the enterprise application platform 102. For example, Force.com™ applications are typically built using Apex™ (a proprietary programming language for Force.com™ that is similar to Java™) and Visualforce™ (a proprietary framework for Force.com™ for developing customized user interfaces). The code used to build add-on applications may include functions that are accessible by the add-on applications. While the Salesforce™ platform is used in the examples described and illustrated herein, other enterprise application platforms, programming languages, and user interface software can also be used with this technology.

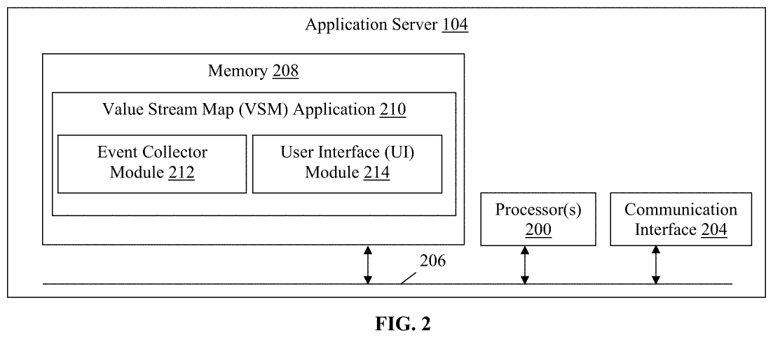

Referring to FIGS. 1-2, the application servers 104 may perform any number of functions, including hosting applications, providing network security, and/or access control, for example. An exemplary one of the application servers 104 is illustrated in FIG. 2. In this example, the application server 104 includes processor(s) 200, memory 202, and a communication interface 204, which are coupled together by a bus 206, although the application server 104 can include other types or numbers of elements in other configurations.

The processor(s) 200 of the application server 104 may execute programmed instructions stored in the memory 208 of the application server 104 for any number of the functions identified above and described and illustrated in more detail below. The processor(s) 200 of the application server 104 may include one or more central processing units (CPUs) or general purpose processors with one or more processing cores, for example, although other types of processor(s) can also be used.

The memory 208 of the application server 104 stores these programmed instructions for one or more aspects of the present technology as described and illustrated herein, although some or all of the programmed instructions could be stored elsewhere. A variety of different types of memory storage devices, such as random access memory (RAM), solid state drives, flash memory, or other computer readable medium which is read from and written to by a magnetic, optical, or other reading and writing system that is coupled to the processor(s) 200, can be used for the memory 208.

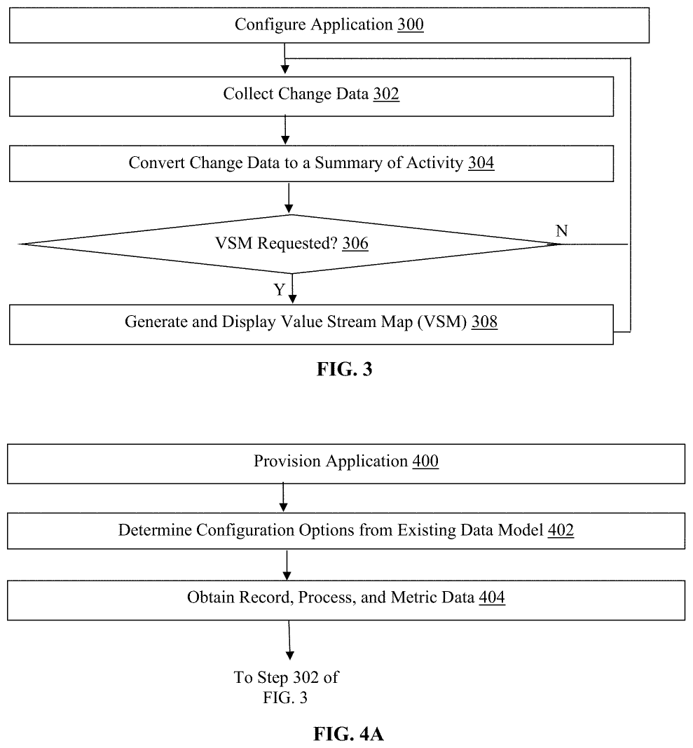

Accordingly, the memory 208 of the application server 104 can store one or more modules that can include computer executable instructions that, when executed by the application server 104, cause the application server 104 to perform actions, such as to transmit, receive, or otherwise process network messages, for example, and to perform other actions described and illustrated below with reference to FIGS. 3-18. The modules can be implemented as components of other modules, application, or add-on applications, for example.

Additionally, the modules may be operative in a cloud-based computing environment. The modules can be executed within or as virtual machine(s) or virtual server(s) that may be managed in a cloud-based computing environment (e.g., enterprise application platform 102). Also, the modules, and even the application server 104 itself, may be located in virtual server(s) running in a cloud-based computing environment rather than being tied to one or more specific physical network computing devices. Also, the modules may be running in one or more virtual machines (VMs) executing on the application server 104 managed or supervised by a hypervisor.

In this particular example, the memory 208 of the application server 104 includes a VSM application 210 that includes an event collector module 212 and a UI module 214, although other modules can be contained within the memory 208 in other examples. The VSM application in this example is configured (e.g., via one of the client devices 106) to collect and analyze certain data to facilitate generation of VSMs. In particular, the client devices 106 can obtain the VSM application as an add-on application within the enterprise application platform 102 and configure the particular metadata objects that represent work items, which fields on those metadata objects represent status fields for the work items, along with additional fields to aggregate and display within the VSM.

In some examples, database tables on the Salesforce® platform are used to represent work items such as cases, opportunities, or user stories, for example, with each record in the tables representing one work item, although other types of work items and/or data stores can also be used. The event collector module 212 is configured to obtain the particular historical data associated with the work items via logs maintained by the enterprise application platform 102 in some examples. After transforming and analyzing the data based on a stored configuration by the VSM application 210, the UI module 214 presents a VSM representing a lifecycle of the work items in the form of a value stream that also includes additional associated metrics regarding a linear process performed on the enterprise application platform 102 and associated with the work items.

More specifically, in some examples a linear sequence of changes to a state field is extracted and transformed on a database record (stored in a field history tracking table associated with a metadata object in a multi-tenant database) to reconstruct a timeline of changes to the work item represented by that record. Metrics such as the amount of time a work item spent in a particular process and the number of times it was returned to that process for re-work are calculated based on the transformed historical log data. The metrics associated with multiple records are aggregated and data about the typical amount of time each work item spends in different stages, and the level of quality at each stage, for example, is displayed in the VSM generated by the UI module 214. The operation of the VSM application 210 is described and illustrated in more detail below with reference to FIGS. 3-18.

Referring back to FIGS. 1-2, the communication interface 204 of the application server 104 operatively couples and communicates between the application server 104 and the client devices 106 that are coupled to the communication network(s) 108, although other types or numbers of communication networks or systems with other types or numbers of connections or configurations to other devices or elements can also be used. By way of example only, the communication network(s) can include local area network(s) (LAN(s)) or wide area network(s) (WAN(s)), and can use TCP/IP over Ethernet and industry-standard protocols, although other types or numbers of protocols or communication networks can be used. The communication network(s) in this example can employ any suitable interface mechanisms and network communication technologies including, for example, Ethernet-based Packet Data Networks (PDNs).

While the application server 104 is illustrated in this example as including a single device, the application server 104 in other examples can include a plurality of devices each having processor(s) (each processor with processing core(s)) that implement one or more steps of this technology. In these examples, one or more of the devices can have a dedicated communication interface or memory. Alternatively, one or more of the devices can utilize the memory, communication interface, or other hardware or software components of one or more other devices included in the application server 104.

Additionally, one or more of the devices that together comprise the application server 104 in other examples can be standalone devices or integrated with one or more other devices or apparatuses. Moreover, one or more of the devices of the application server 104 in these examples can be in a same or a different communication network including one or more public, private, or cloud networks, for example.

The client devices 106 of the network environment 100 in this example include any type of computing device that can exchange network data, such as mobile, desktop, laptop, Internet of Things (IOT), or tablet computing devices, virtual machines (including cloud-based computers), or the like. Each of the client devices 106 in this example includes a processor, a memory, and a communication interface, which are coupled together by a bus or other communication link (not illustrated), although other numbers or types of components could also be used.

The client devices 106 may run interface applications, such as standard web browsers or standalone client applications, which may provide an interface to make requests for, and receive content stored on, one or more of the application server 104 via the communication network(s) 108. The client devices 106 may further include a display device, such as a display screen or touchscreen, or an input device, such as a keyboard for example (not illustrated).

Although the exemplary network environment with the network application servers 104, client devices 106, and communication network(s) 108 are described and illustrated herein, other types or numbers of systems, devices, components, or elements in other topologies can be used. It is to be understood that the systems of the examples described herein are for exemplary purposes, as many variations of the specific hardware and software used to implement the examples are possible, as will be appreciated by those skilled in the relevant art(s).

The examples may also be embodied as one or more non-transitory computer readable media having instructions stored thereon, such as in the memory 208 of the application server 104, for one or more aspects of the present technology, as described and illustrated by way of the examples herein. The instructions in some examples include executable code that, when executed by one or more processors, such as the processor(s) 200 of the application server 104, cause the processors to carry out steps necessary to implement the methods of the examples of this technology that are described and illustrated herein.

Referring more specifically to FIG. 3, a flowchart of an exemplary method of value stream mapping and management of processes tracked in computer systems is illustrated. At a relatively high level, there are five aspects to this technology, which correspond to stages of creating a VSM based on source data, which include collecting change or event data, configuring the application, processing the collected change data, generating and displaying a user interface that includes a VSM, and generating and displaying analytics. Each of these aspects will now be explained in more detail with reference to FIG. 3.

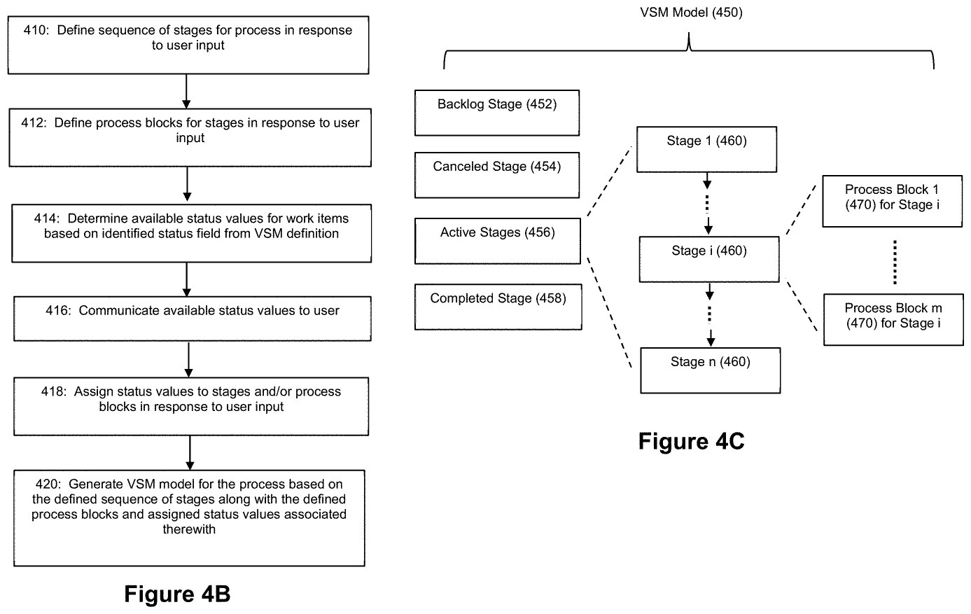

In step 300 in this example, the application server 104 configures the VSM application 210 based on input from one of the client devices 106 or an administrator device (not shown) in the network environment 100. Configuring the VSM application 210 in this particular example includes provisioning the VSM application 210; reading an existing data model to determine configuration options; and obtaining records of interest; process data for the processes involved in the value stream; and metric data. Each of these aspects will now be described in more detail with reference to FIG. 4A in which a flowchart of an exemplary method for application provisioning to facilitate data collection useful for generating VSMs and associated analytics is illustrated.

In step 400 of FIG. 4A in this example, the application server 104 provisions the VSM application 210, which can be in response to a selection from one of the client devices 106 of the VSM application 210 from a repository of add-on applications available within the enterprise application platform 102. Accordingly, the VSM application 210 in some examples can be a multi-tenant system that isolates data into different tenants pertaining to an organization, or a copy of the VSM application 210 can be installed in an organization's private network. For each tenant or installation, administrators can create one or more distinct VSMs to describe different work processes.

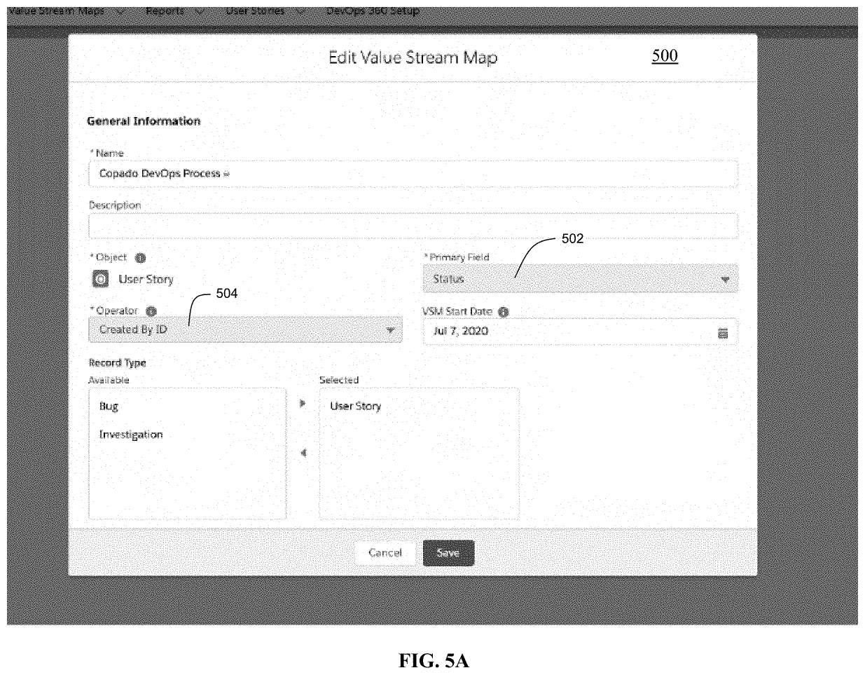

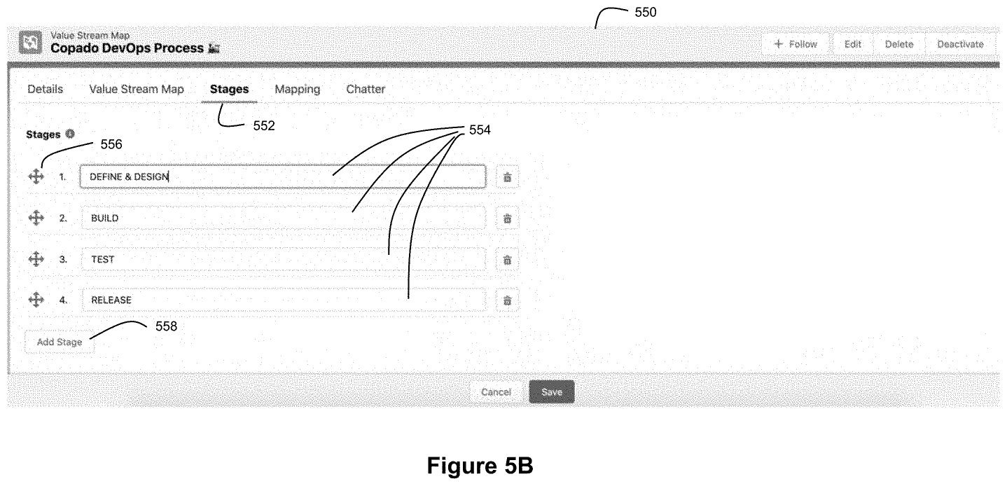

In step 402, the application server 104 obtains or determines configuration options. Referring to FIG. 5A, an exemplary value stream definition interface 500 is illustrated. The value stream definition interface 500 can be provided by the application server 104 to one of the client devices 106, such as a client device used by an administrator. In this example, the administrator can specify a name for a new VSM to be created as well as select the work items to be tracked, which collectively form part of the configuration options.

To define the work items to be tracked, in one example an administrator can select a database table or object that contains records for the work items. In this example, there is one data record in the object for each work item and each object has a corresponding schema, which is readable by the created VSM. Table 1 illustrates a sample data model for the objects that track work items:

TABLE 1
Object: MyWorkItems

| Work | | | | | | |
|---|---|---|---|---|---|---|
| Item | Record | Development | Development | Documentation | Documentation | Metric |
| ID | Type | Status | Worker | Status | Worker | 1 |
| 1000 | Planned | In Progress | Alice | Not Started | Charlotte | 500 |
| | Work | | | | | |
| 1001 | Unplanned | Completed | Alice | In Progress | Dave | 20 |
| | Work | | | | | |
| 1002 | Unplanned | In Progress | Bob | Completed | Charlotte | 1300 |
| | Work | | | | | |
| 1003 | Planned | Backlog | Bob | Backlog | Charlotte | 100 |
| | Work | | | | | |

As illustrated in FIG. 5A, for each VSM, an administrator can choose the object that will be tracked in the VSM and also choose, via field selection menu 502, the field on that object that contains the status value of the object in the VSM. Optionally, an administrator can specify that a VSM should reflect only data that is of one or more record types. There can be multiple VSMs configured per object as long as they use different fields to specify the state and/or different record types. Also as reflected in the value stream definition interface 500, an administrator can choose, via operator selection menu 504, which field on the object represents the worker or operator responsible for that work item. Optionally, that field can be constrained to only list selectable fields based on a link to another database table of workers.

The application server 104 can also facilitate definition of the process involved in the value stream for the new VSM in step 402. A value stream as used herein is a series of sub-processes that result in a valuable output. This technology provides a user interface for defining and displaying the sequence of sub-processes involved in a particular process that is tracked and reflected by the VSM. Thus, step 402 can also include defining the VSM model that will be used to represent the process that is applicable to the work items. FIG. 4B shows an example process flow for execution by one or more processors within the system 100 to create the VSM model in response to user input.

FIG. 4C shows an example of a VSM model 450 that can be created based on the process flow of FIG. 4B. The VSM model 450 includes a plurality of active stages 456 that represent the stages that a work item will pass through as work is performed by personnel as part of the modeled process. The active stages 456 are arranged as a sequence of stages 460 to define an order for the active stages 456 within the process (e.g., a linear sequence). User input via one or more GUIs can control how many stages 460 are included among the active stages 456 and the order of such stages 460 in the sequence. Each stage 460 among the active stages 456 may comprise one or more process blocks 470 that represent sub-processes within each stage 460. If a given stage 460 has multiple process blocks 470 within it, these process blocks 470 can represent parallel sub-processes. Furthermore, in an example embodiment, each active stage 460 can have a process block 470 that corresponds to a waiting stage for that active stage 460 in addition to one or more other process blocks 470. User input via one or more GUIs can control how many process blocks 470 are included for each the stage 460 among the active stages 456.

The VSM model 450 may further comprise a backlog stage 452, a canceled stage 454, and a completed stage 458 as discussed in greater detail below.

At step 410 of FIG. 4B, the system defines the sequence of stages 460 for the active stages 456 of the process to be modeled. This definition is performed in response to user input. FIG. 5A shows an example GUI 550 for users to define the sequence of stages 460. The GUI 550 can be accessed in response to selection of the “Stages” tab 552. GUI 550 includes a plurality of input fields 554 through which the user can define a stage 460 to be added to the VSM model 450. The user input in fields 554 can be the names for the respective stages 460. Furthermore, each field 554 can have a corresponding arrow icon 556 that is selectable by the user to control the order of the stages 460 defined via fields 554 within the subject process for the VSM model 450. For example, a given stage 460 can be moved later in the process or earlier in the process in response to appropriate user manipulation of arrow icons 556. Furthermore, should the user need to define additional stages 460 for the subject process, the user can select the “Add Stage” button 558 to access additional input fields 554.

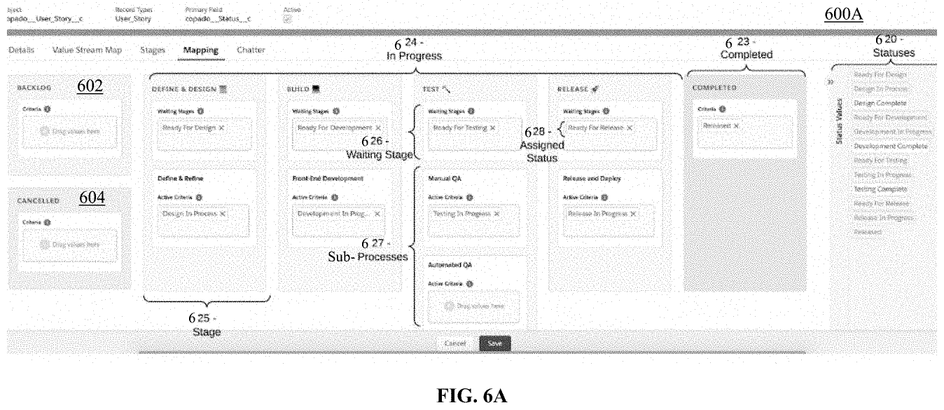

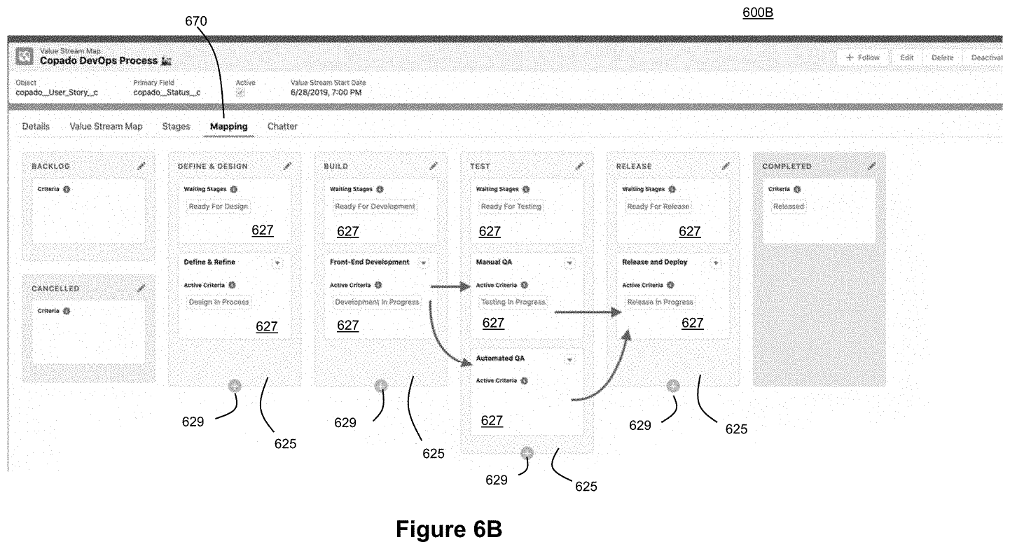

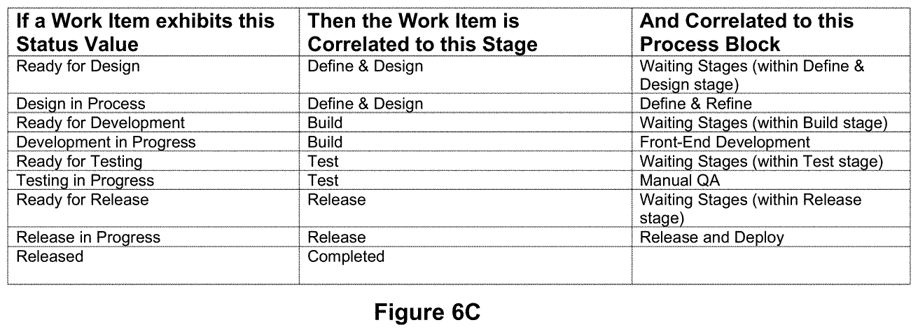

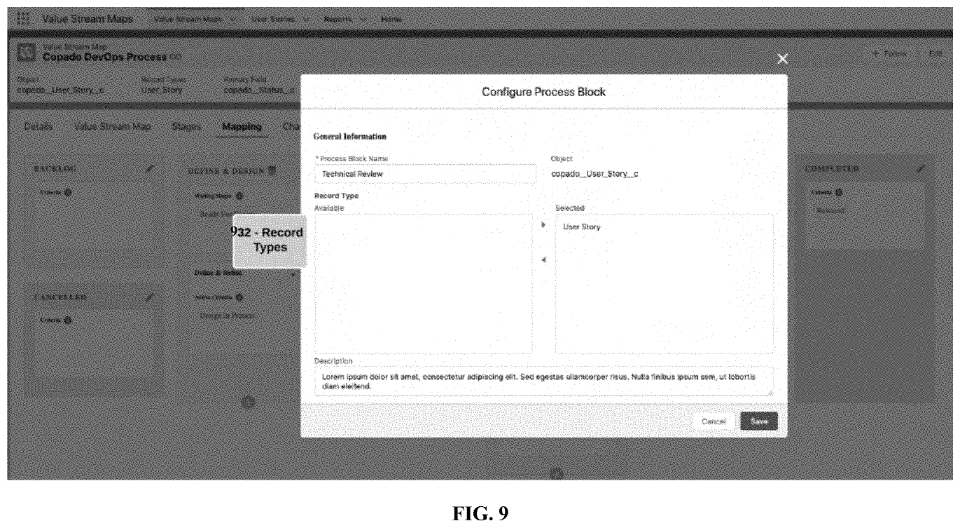

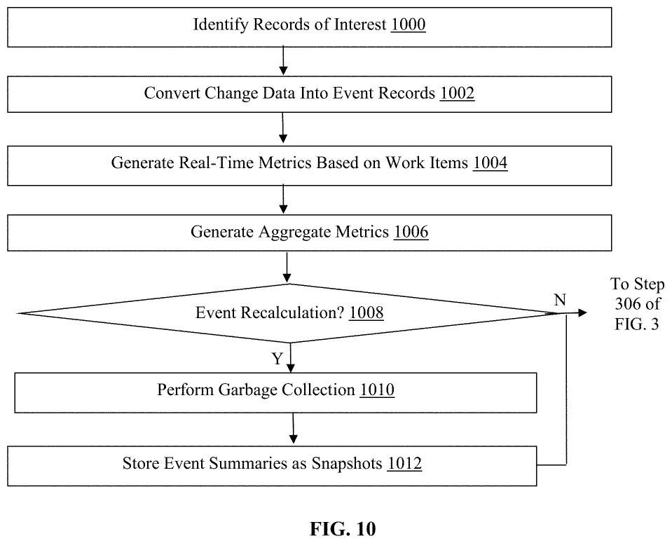

At step 412, the system defines one or more process blocks 470 for one or more of the stages 460. This definition is performed in response to user input. FIG. 9 discussed in greater detail below shows an example GUI for users to define process blocks 470. The GUI of FIG. 9 can be accessed via user selection of an addition button 629 or the like as shown by FIG. 6B in association with each stage-specific progress panel 625. The GUI 600B of FIG. 6B can be accessed in response to user selection of the “Mapping” tab 670. From the GUI of FIG. 9, the user can provide a name and description for each process block 470 to be added to a stage 460. As process blocks 470 are created, these will be shown as elements 627 within the stage-specific progress panels 626 of GUI 600B shown by FIG. 6B. The user may create multiple process blocks 470 per stage 460. FIG. 6B shows an example of how the flow through the process defined by the sequence of stages 460 and their corresponding process blocks 470 would occur (see the arrows in FIG. 6B). For example, if a given stage 460 such as the “Test” stage shown by FIG. 6B has multiple process blocks 470, these process blocks 470 can exist as parallel process blocks within the “Test” stage. Thus, it should be understood that the process blocks 470 within a stage 460 need not have an associated sequence or order relative to each other.

The system can then operate to create a mapping between (1) the status values that can be exhibited by the work items of the process and (2) the stages 460 and/or process blocks 470 so the system can properly consider the progress that the work items being tracked make through the modeled process. Steps 414, 416, and 418 of FIG. 4B relate to this mapping.

At step 414, the system determines the available status values for the work items based on the field from the work items records that was identified via 502 from FIG. 5A as containing the status values for the work items. The system can identify the different status values that are exhibited in the status field of these records as the universe of available status values for the process to be modeled. As another example, the system can access some other model or schema that identifies the universe of available status values.

At step 416, the system communicates the determined available status values to the user. For example, a GUI presented to the user can show a list or menu of such status values (e.g., see 620 in FIG. 6A discussed below).

At step 418, the system assigns the status values to stages 460 and/or process blocks 470 in response to user input. For example, FIG. 6A shows an example where a user can use “drag and drop” functionality to assign different individual status values from 620 to different process blocks 470 (e.g., see 626 and 627 in FIG. 6A).

Based on these assignments from step 418, the system generates the VSM model 450 for the process (step 420). In addition to the defined sequence of stages 460, where each stage 460 comprises one or more process blocks 470, this VSM model 450 also includes a mapping of assigned status values for the process blocks 470 and/or stages 460.

Referring to FIGS. 6A-B, exemplary value stream configuration interfaces 600A and 600B are illustrated. In the example of FIGS. 6A and 6B, it can be seen that the sequence of stages 460 for the VSM model 450 as reflected within the in-progress panel 625 of the GUI 600A comprise the following: (1) a “Define & Design” stage followed by (2) a “Build” stage followed by (3) a “Test” stage followed by (4) a “Release” stage. Furthermore, in this example, the “Define & Design” stage includes the following process blocks 470: (1) a “Waiting Stages” process block and (2) a “Define & Refine” process block. The “Build” stage includes the following process blocks 470: (1) a “Waiting Stages” process block and (2) a “Front-End Development” process block. The “Test” stage includes the following process blocks 470: (1) a “Waiting Stages” process block, (2) a “Manual QA” process block, and (3) an “Automated QA” process block. Moreover, the “Release” stage includes the following process blocks 470: (1) a “Waiting Stages” process block and (2) a “Release and Deploy” process block.

Based on the object and status field values obtained in step 402 and the determination from step 414 of FIG. 4B, the application server 104 outputs a status list 620 of allowed status values for the status field. As discussed above, the status list 620 can be defined either explicitly as part of the database schema or implicitly by enumerating unique values in the database, for example, and other methods for defining the status list 620 can also be used. The status values in the status list 620 are allocated to different process blocks that are within stages of the overall process associated with the VSM and correspond to sub-processes of that overall process as discussed above in connection with FIG. 4B.

In this example, the allocation or assignment of one or more of the statuses can be achieved via a dragging of a status value from list 620 into a process block within a stage of a graphical panel within the value stream configuration interface 600A, although other methods for allocating statuses can also be used. Status values can also be allocated to stages of the VSM model 450 including the backlog stage 452 (see 602 of FIG. 6A), the canceled stage 454 (see 604 of FIG. 6A), the completed stage 458 (see 623 of FIG. 6A), or to one of the active stages 456 in the in-progress panel 624 (e.g., stage 625) in this example, and status values from the status list 620 also can remain unallocated if considered appropriate by the user.

Each active stage 456 in this example includes a process block 470 that serves as a waiting area (e.g., waiting stage 626) and corresponds to delays or queues between active work. As noted above, within each stage 460 of the VSM model 450, users such as administrators can define one or more parallel sub-processes via process blocks (e.g., process blocks 627) that correspond to active work done in that stage. These serial stages and parallel sub-processes are defined via a model of the value stream (e.g., the VSM model 450), the process through which work is completed. Each waiting area or sub-process in the VSM model 450 typically corresponds to one or more status values (e.g., assigned status 628) for a record. Accordingly, the status field values are correlated to parts or stages of the value stream process. This mapping establishes a relationship between the metadata objects, fields, process blocks, stages, and VSM definition, which is the foundation for analyzing change data to determine the history of work item progress, as described and illustrated in detail below.

FIG. 6B shows an example GUI 600B that shows the mapping of status values to process blocks 470 after step 418 has been completed. As can be seen from FIG. 6B, each process block 470 within the sequence of stages 460 is displayed in association with the status value mapped thereto. This, according to the VSM model 450 represented by FIG. 6B, work items that exhibit various status values can be correlated to stages 460, 458 and process blocks 470 as reflected by FIG. 6C.

In step 404, the application server 104 obtains record, process, and metric data for the new VSM corresponding to the VSM model 450. The object schema in this example includes fields of different types and the schema for each object includes at least one field that represents the status of the work item using a fixed set of values. There can be multiple fields that represent the status of the work item from different perspectives. Additionally, there may be a field in the object that defines the record type and distinguishes different categories of work item.

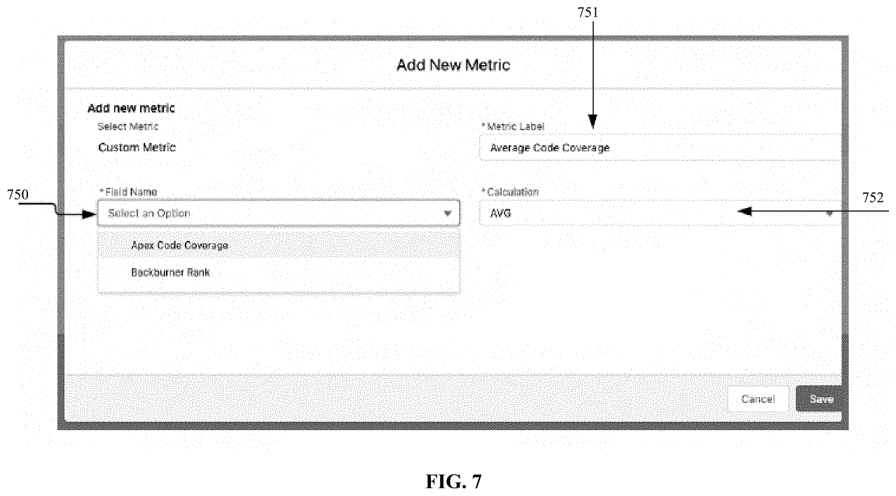

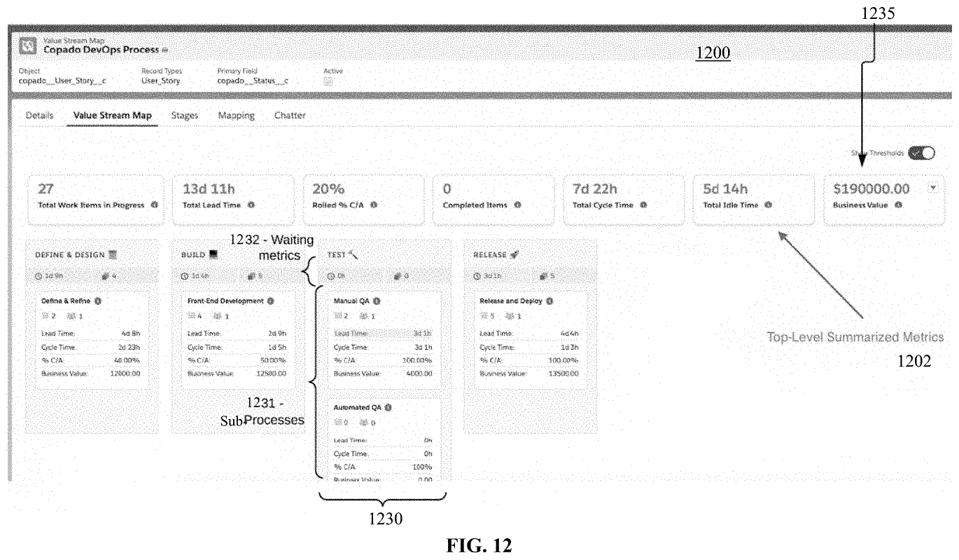

The application server 104 also obtains metric data in step 404, although certain metrics such as lead time can be automatically calculated as default metrics on every VSM. The metric data can be obtained via a provided interface, such as the exemplary new metric interface 700 illustrated in FIG. 7. In this example, custom metrics that should be summed or averaged, for example, and displayed alongside other metrics can be defined. In particular, an administrator, for example, can select from a field name menu 750 that identifies numeric fields in the database object that can be used as custom metrics. Each metric can be given a label entered into a label field 751 and the calculation (e.g., an average or AVG) can be defined for the metric label associated with the selected field via a calculation field 752. In this example, custom metrics will be displayed alongside other top-level metrics on the VSM, as described and illustrated in more detail below with reference to FIG. 12.

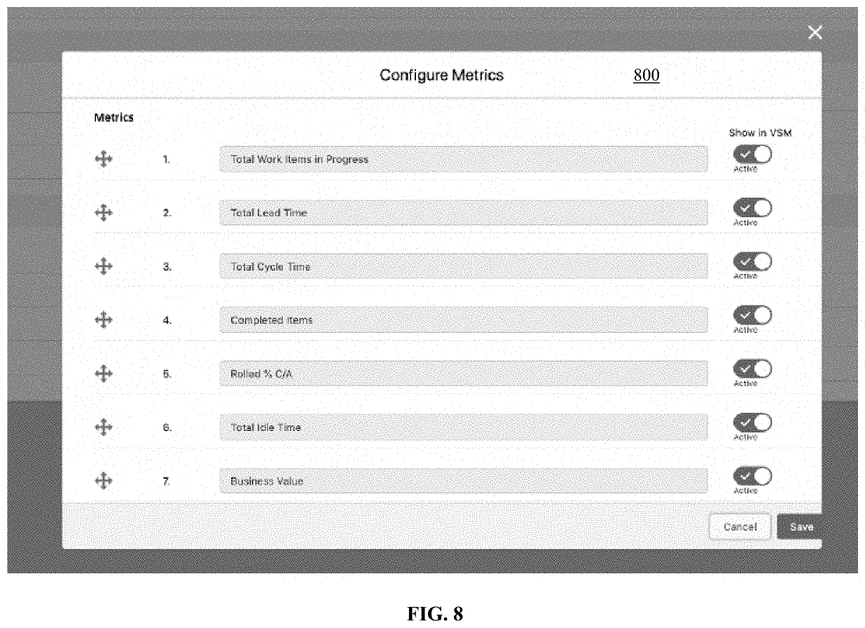

Referring now to FIG. 8, an exemplary metric configuration interface 800 is illustrated. The metric configuration interface 800 can be used by an administrator, for example, to toggle the display of metrics as well as the order of the metrics, including custom metrics. The application server 104 in this example stores the record, process, and metric data obtained in step 404 to facilitate the subsequent generation of the VSM upon request, also as described and illustrated in more detail below.

Referring back to FIG. 6B, the value stream configuration interface 600B is configured to facilitate the creation of new process blocks via a selectable input 629, which can be done prior to the mapping facilitated by the value stream configuration interface 600A as described and illustrated in more detail above with reference to FIG. 6A. As noted above, the he process blocks correspond with sub-processes of the overall tracked process associated with the VSM. Optionally, administrators can create multiple process blocks per stage. Referring to FIG. 9, an exemplary process block creation interface is illustrated. As illustrated in FIG. 9, any number of record types 932 can be included or excluded from created process blocks as part of the configuration.

Referring back to FIG. 3, in step 302, the application server 104 collects change data from database(s) associated with the enterprise application platform 102. The change data can be collected periodically via an interface (e.g., an API) provided by the enterprise application platform 102, for example, although other methods for obtaining the change data can also be used. In some examples, the enterprise application platform 102 is configured to maintain activity or event logs that maintain the change data.

The change data is the source data for the VSM and includes a sequence of records representing changes to the state of work items over time. The sequence of data covers changes over an unbroken period of time, although the change data can reflect a partial history including any portion of the overall history of changes for a process. In this particular example, the change data can include a history of changes to the state of a work item, as recorded in a database record, or a history of processes executed over time on those database records. In both cases, the data sources may be derived from other systems, as long as the history of changes in those systems can be put into the particular format described and illustrated by way of the examples herein.

The first type of change data is a history of changes to the state of work items. The source for this change data can be a database table that includes fields which track changes to the state of each work item as each work item progresses through the overall work process. Changes to the state of a work item are stored in a separate history table in a database in this example. Each time the state of the work item changes, a record is made of this change data in the history table. The record in some examples includes a timestamp, an identifier (ID) of the record that was changed, a name of the associated status field, an original state, and a new state.

Some databases such as those hosted on the Salesforce™ platform can create change records automatically whenever a field history tracking feature is enabled for the status field on the work item record. Table 2 illustrates a sample format for status change data on work items:

TABLE 2

| Work | | Field | | |
|---|---|---|---|---|
| Item ID | Timestamp | Changed | Old Value | New Value |
| 1000 | Dec. 2, 2017 | WorkStatus | Planned | In Progress |
| | 2:39:58 AM | | | |
| 1000 | Dec. 2, 2017 | WorkStatus | In Progress | Validating |
| | 2:41:12 AM | | | |
| 1000 | Dec. 2, 2017 | WorkStatus | Validating | Complete |
| | 2:43:26 AM | | | |

The second type of change data is a history of processes executed related to work items. The source for this change data can be a sequential record of activities performed as part of the process associated with the VSM. Whereas the previous data source tracked changes to the status of a work item (for example, a work item moving from planned to in-progress to complete), the source for this second type of change data contains a sequence of records of activities performed on a work item. Each activity record includes or implies the start time of a process and its duration. The activity records in this example also include an identifier for the work item being processed, an identifier for the type of activity being performed, and a success or failure result. The software development process involves the use of a wide variety of tools, each of which generates their own event log. These event logs record the history of activities that are performed by that tool. But the software development process can employ many tools each with their own distinct event log, and none of them contain a complete picture of all activities performed in the development process. Also, those logs are organized by tool and by time, rather than showing the information organized based on work item. The VSM tool aggregates all of these event logs, and it organizes them by work item. If these event logs are comprehensive, they can also be used to reconstruct a picture of the complete sequence of activities performed on a work item. Table 3 illustrates a sample format for activity records, which is converted by the application server 104 in step 302 in this example into the format illustrated in Table 2. With respect to Table 3, the Activity ID field can contain a unique identifier for a single activity record, The Activity Type field can contain an identifier that indicates the type of activity being performed in the system. The Work Item ID field can contain the identifier for the work item was the subject of the relevant activity type. The Start Time and Duration fields can contain, respectively, values that identify the time that the subject activity started and the length of time that this activity took. The Results field can identify the result of the activity (e.g., Success or Failure). When converting activity records (see Table 3) into a change log of work item status (see Table 2), the system can (1) leverage the Work Item ID field from Table 3 to identify the relevant work items, (2) use a mapping of Activity Types and Results from Table 3 to status changes for the subject work item, and (3) translate the Start Time and Duration values from Table 3 into a time stamp value for work item status changes.

TABLE 3

| Activity | Activity | Work | | | |
|---|---|---|---|---|---|
| ID | Type | Item ID | Start Time | Duration | Results |
| 423252 | Validate | 1000 | Dec. 2, 2017 | 0:00:15.000 | Fail |
| | Package | | 2:39:58 AM | | |
| 235855 | Run Unit | 1001 | Dec. 2, 2017 | 0:12:52.000 | Success |
| | Tests | | 2:43:26 AM | | |
| 423265 | Validate | 1000 | Dec. 2, 2017 | 0:00:46.000 | Success |
| | Package | | 2:57:22 AM | | |

In step 304, the application server 104 converts the change data collected in step 302 into a summary of activity. Converting the change data into the summary of activity includes identifying records of interest, converting change data into event records, calculating real-time metrics based on work items, processing individual records, calculating aggregate metrics, event recalculation, garbage collection, storing event summaries as snapshots, and high-volume data processing, which will now be described and in detail with reference to FIG. 10.

FIG. 10 illustrates a flowchart of an exemplary method for converting change data to a summary of activity useful for generating VSMs and associated analytics. In step 1000 in this example, the application server 104 identifies records of interest from the state change and activity records generated from the change data collected in step 302. Records of interest in this example are identified based on the parameters defined during VSM application 210 configuration in step 300. After this initial configuration is completed, a VSM can be activated.

Upon activation, the full list of change data is filtered to include only those records that match the object, record type, status field, and status field values. Each VSM is specific to a particular object, record type, and status field. Within the status field, only values that are mapped to stages in an in-progress panel (e.g., in-progress panel 624) or a completed stage (e.g., completed stage 623) of the VSM are included in calculations of the event records. The remaining set of records are the basis for generating metrics for a particular VSM.

In step 1002, the application server 104 converts change data into event records by processing the records of interest and converting those records into event records. Event records track changes that are relevant to a particular VSM, such as entering a particular sub-process, leaving that sub-process, or returning to a prior stage for example. The records of interest are processed to reconstruct the timeline of changes to the work item represented by that record. The history of status changes is stored and processed in sequential order to simplify creation of the timeline.

Accordingly, each state change record is processed to determine whether it reflects a movement of a work item into or out of a different portion of the VSM, such as a waiting area (e.g., waiting stage 626). Status changes that only reflect movement inside of an panel (e.g., changing state between two statuses that are both in the same waiting area) are ignored. Event records are stored in a separate database table in some examples.

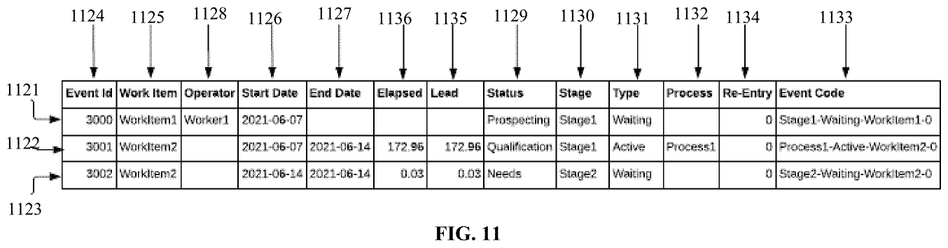

Referring to FIG. 11, a screenshot 1100 of exemplary event records 1121, 1122, and 1123 is illustrated. Each event record 1121, 1122, and 1123 in this example has a unique Event ID 124. When a status change record reflects the entry of a work item 1125 into a waiting or active stage, an event record is created that includes a start date/time 1126. When a status change record reflects the exit of a work item from a waiting or active stage, the event record related to its entry is updated to include an end date/time 1127. If no prior event record is found, a new event record is created that includes only the end date/time 1127. Each of the event records 1121, 1122, and 1123 includes an indication of the work item 1125 (e.g., a work item ID) being changed, the operator assigned to the work item 1128, the status that the work item moved into or out of 1129, the stage that this status is assigned to 1130, whether the status is assigned to a waiting or active part of the stage 1131, and, if the status is assigned to an active stage, the sub-process to which the status is assigned 1132.

In some examples, the quality of work done in a VSM is measured based on whether work in one stage is complete and accurate. Work that is complete and accurate as used herein is work that moves onto subsequent stages and never return to the prior stage. Re-entry is defined as a work item that has left a stage and moved forward but then returned to a previous stage. An event code 1133 is used to track whether work leaving each stage is complete and accurate. The combination of stage 1130, active/waiting 1131, and work item ID 1125 are concatenated into the event code 1133 in this example. This event code 1133 is used to identify whether this is the first instance of that particular work item entering that particular stage.

Additionally, the first time a work item 1125 enters the waiting or active area of a stage the event is given a re-entry number 1134 of “0,” which is added (e.g., appended) to the event code 1133. If that work item 1125 subsequently re-enters that particular waiting or active stage, it is deemed that there was a quality issue that demanded re-work. A new event record is then generated and given a re-entry number 1134 that is updated (e.g., incremented by 1) from the previous value, and this re-entry number 1134 is again added to the event code 1133. For events that include both a start date/time 1126 and 1127 an end date/time, a lead time 1135 and an elapsed time 1136 can also be calculated from the those values and included in the event records 1121, 1122, and 1123.

Further, if an event record 1121, 1122, and 1123 is updated and has skipped a waiting criteria section, then the event record entry and exit times are equal to account for the movement of work. Although the event record would not therefore reflect time spent in the waiting area, the work item 1125 will be tracked in this example, which is required to generate an accurate historical average for metrics such as idle time, lead time, cycle time, and percentage complete and accurate. Accordingly, the event records 1121, 1122, 1123 are summarized to generate historical cycle time, historical lead time, historical and current idle time, and the percentage complete and accurate metrics at the granularity of individual stages and sub-processes, which are totaled to generate the metrics for the value stream as a whole.

In step 1004, the application server 104 generates real-time metrics based on work items. Status values that are assigned to the backlog stage (e.g., backlog stage 621) during the mapping described and illustrated in more detail above with reference to step 300 and FIG. 6A identify work that is waiting in a queue. In some examples, the number of items in a backlog state is a real-time metric calculated based on the number of work items that have statuses assigned to the backlog stage. Work items associated with a backlog status do not generate event records nor contribute to the lead time, cycle time, percentage complete and accurate, or any custom metrics in some examples.

Status values which are applied to a cancelled stage (e.g., cancelled stage 622) during the mapping described and illustrated in more detail above with reference to step 300 and FIG. 6A identify work that is cancelled and is no longer being worked by any operators or workers. The number of items in a cancelled state is a real-time metric calculated based on the number of work items that have statuses assigned to the cancelled state. Other metrics, such as cancellation rate, can be calculated by comparing work items that were once active but have now been cancelled.

Status values which are assigned to a completed stage (e.g., completed stage 623) during the mapping described and illustrated in more detail above with reference to step 300 and FIG. 6A identify work that is completed. The VSM can display metrics on completion rate, number of items in a completed state, and time-to-completion. Any items associated with a completed state have exited an in-progress stage and do not generate event records nor contribute to the number of work items in progress metric.

Status values assigned to one of the stages in an in-progress panels (e.g., in-progress panel 624) during the mapping described and illustrated in more detail above with reference to step 300 and FIG. 6A identify work that is in-progress and actively being worked by identified workers/operators. In addition to the events described above, in-progress work items contribute to metrics such as current number of work items and number of unique workers/operators, for example. Accordingly, in step 1004, the application server 104 processes the event records generated in step 1002 to generate various real-time metrics based on the work items identified therein, which can subsequently be incorporated into and displayed via the VSM.

In step 1006, the application server 104 generates aggregate metrics for subsequent inclusion in the VSM. Aggregate metrics are based on the events generated from work items that have moved through in-progress stages associated. Aggregation of metrics for lead time, cycle time, percentage complete and accurate, and idle time, for example, are divided by stages to provide a weighted historical average for all stage, process block, and top level metrics.

Idle time as used herein relates to the historical time a work item spent in a waiting stage. Idle Time has a corresponding work item count which displays in real-time how many work items are currently contributing to the idle time. Cycle time as used herein is the actual operating time for a work item and is calculated from the event records by summing the amount of time work items spend in a process block (i.e., an active state).

Lead Time within the process block as used herein is determined by taking a sum of the historical idle time plus the cycle time for a given stage and the associated process block. The overall lead time for the VSM is the sum of lead times for all of the stages. For stages that contain multiple process blocks, a weighted average of the lead times for those process blocks is used. For example, assume there are two parallel process blocks corresponding to sub-processes of the overall process represented by the VSM in one stage, 20% of work items pass through sub-process 1 taking an average of 10 hours to complete, and 80% of work items pass through sub-process 2 taking an average of 5 hours to complete. In this particular example, the weighted average of lead time for this stage is 20%*10 hours+80%*5 hours=6 hours.

In some examples, quality is measured based on a percentage complete and accurate metric, which corresponds with how frequently work items are sent back to a previous stage or process block within a stage. The overall percentage complete and accurate metric for the VSM is the product of the percentage complete and accurate for all stages. For example, if there are two stages, and the first stage is 80% complete and accurate and the second stage is 50% complete and accurate, then the value stream is 40% complete and accurate. Work items and operators that are displayed in the process blocks and stages are advantageously determined in real-time to show the exact work item counts and associated operators based on the VSM configuration.

Additionally, custom metrics can be calculated for use cases where end users require a set of unique metrics to be displayed on the VSM. The custom metric can be calculated from any numeric field that is on the metadata object associated with the VSM. Custom metrics defined for that VSM can be either summed or averaged, for example, and other types of calculations for custom or other metrics can also be used in other examples. Accordingly, in step 1006, the application server 104 processes the event records generated in step 1002 to generate various aggregate metrics based on the work items identified therein, which can subsequently be incorporated into and displayed via the VSM.

In step 1008, the application server 104 optionally determines whether a recalculation event has occurred as a result of a change to the VSM definition, for example. When the definition of a VSM is changed, the events associated with that VSM become outdated and can be deleted (e.g., via marking as inactive and a subsequent garbage collection). VSM changes that result in a recalculation event and potential invalidation of events include a change in a status tied to a process block, removal of a process block from a stage, creation of a process blocks, and removal or creation of a stage, for example. Event records marked as inactive are excluded from metric calculations.

In some examples, the condition in step 1008 is checked periodically and in other examples the VSM application 210 provides a selectable input element (e.g., a button) that facilitates a forced recalculation. If the application server 104 determines that a recalculation event has not occurred, then the No branch is taken back to step 310 of FIG. 3. However, if the application server 104 determines that a recalculation event has occurred, then the Yes branch is taken to step 1010.

In step 1010, the application server 104 performs a garbage collection process. While in this example the garbage collection is performed when a recalculation event is determined to have occurred, the garbage collection can also be performed at other times independent of the recalculation events in other examples. To perform garbage collection, the application server 104 identifies inactive event records (e.g., event records marked as inactive due to a deletion).

In addition to a recalculation event, events records can be marked as inactive as a result of being directly deleted or as a result of an association with a deleted process block, stage, or VSM, for example. In the event that a work item is deleted, any associated event records are identified and marked as inactive. Accordingly, the garbage collection process is a mechanism for the application server 104 to delete inactive event records as a result of a deletion of a work item, a deletion of a VSM, or a change in configuration of a VSM, for example.

In step 1012, the application server 104 stores event summaries as snapshots. As with step 1010, the application server can store event summaries as snapshots independent of the event recalculation determination in other examples. In this example, the application server 104 can store pre-processed metrics for faster display, which is particularly advantageous for processes that are associated with large amounts of data. The event summary snapshots can be stored as files that are used bypass the need to calculate particular data or metrics with every display of the VSM. The snapshot files also avoid processing limits which may be enforced by the underlying enterprise application platform 102. Subsequent to storing event summaries as snapshots in step 1012, the application server proceeds back to step 306 of FIG. 3 in this example.

In step 306, the application server 104 determines whether a VSM is requested. The VSM can be requested by any of the client devices 106 via the communication network(s) 108. Users can select to view a particular VSM by reviewing a list of the created VSMs, for example. If the application server 104 determines that a VSM has not been requested, then the No branch is taken back to step 302 and the application server 104 continues to periodically collect change data and convert the change data to a summary of activity. However, if the application server 104 determines that a VSM has been requested, then the Yes branch is taken to step 308.

Internet applications typically emphasize either server-side processing or client-side processing. With server-side processing, most processing is done on a central server, where the central server computes the resulting output and sends it to a web browser which functions as a “dumb client”. Client-side processing takes advantage of the significant data storage and computing capacity of modern web browsers and end user computing devices to manage raw data processing and to generate their own UI as a “smart client”. The VSM system described herein allows for example embodiments to employ either or both modes of operation. In the server-side processing model, in step 308, the application server 104 generates and displays the requested VSM. The VSM includes metrics with varying levels of granularity that are generated as described and illustrated in detail above with reference to steps 1002-1004 of FIG. 10. But calculating all of the metrics on the application server 104 with each view requires a large number of calculations to be performed by server 104 in a short span of time, and so can cause delays in page loading and high volumes of database queries. To optimize display time, the VSM system can also use a client-side processing model. In this case, each stage and process block can be associated with client-side code that runs in a web browser executed by a client device 106. This client-side code allows each stage and process block to request that the application server 104 send the raw data related to that stage or process block to the client-side code on the client device 106. That data is then processed on the client device 106. Data related to each stage or process block is transmitted over the network to the client device 106 and processed on the client device 106 in parallel. This parallel loading allows the results for one process block to be displayed by the client device 106 before another one has finished its calculations. This progressive loading and display creates a responsive user experience that allows the pages of a VSM to load relatively quickly and metrics to be displayed as the data is returned from the application server 104.

Referring to FIG. 12, an exemplary VSM 1200 is illustrated. The stage display 1230 and sub-process display 1231 in this example are based on the stage 625 and process blocks 627 in the in-progress panel 624 of the value stream configuration interface 600A. At the top of each stage display are metrics 1232 on the typical idle time and number of items currently waiting to be processed in that stage in this particular example. The calculated metrics are overlaid on top of the VSM 1200 after it is configured, mapped, and activated. Additionally, custom metrics 1235 established as described and illustrated above are displayed alongside other top-level aggregate or summarized metrics 1202 in this example.

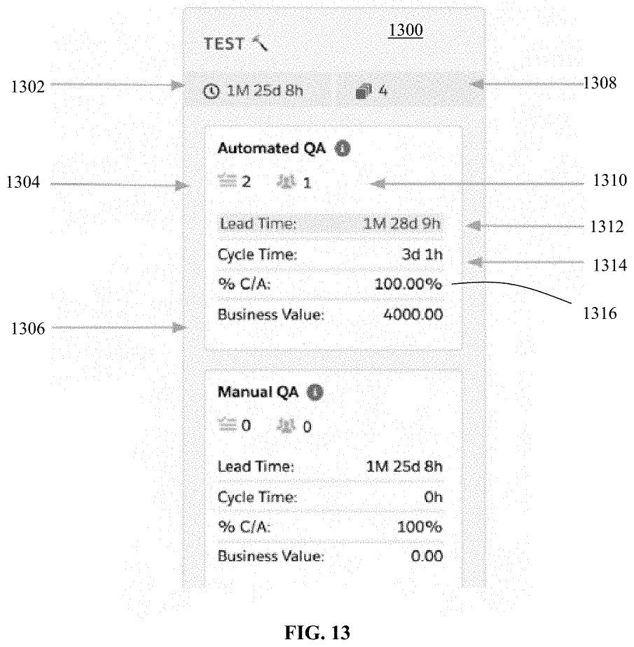

Referring to FIG. 13, a screenshot 1300 of exemplary value stream management metrics details for a stage is illustrated. The metrics details shown in FIG. 13 illustrate the variety of metrics that are made available to the user through the VSM for process blocks within a stage. In this particular example, the metrics details include the idle time 1302, number of items in the particular process block 1304, custom metrics 1306, number of items in waiting section 1308, number of operators 1310, lead time 1312, cycle time 1314, and percentage complete and accurate 1316, although any number of other metrics can also be used in other examples.

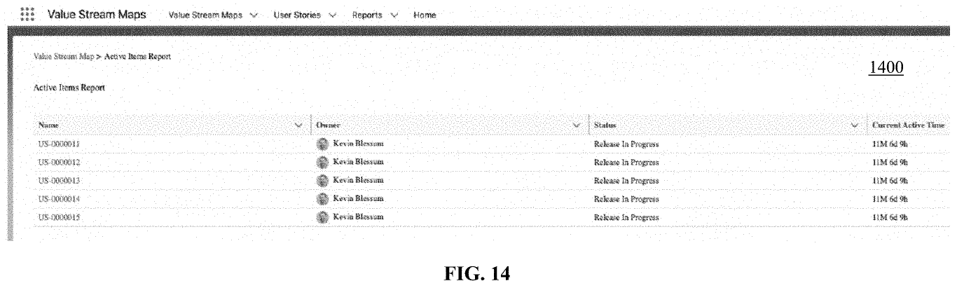

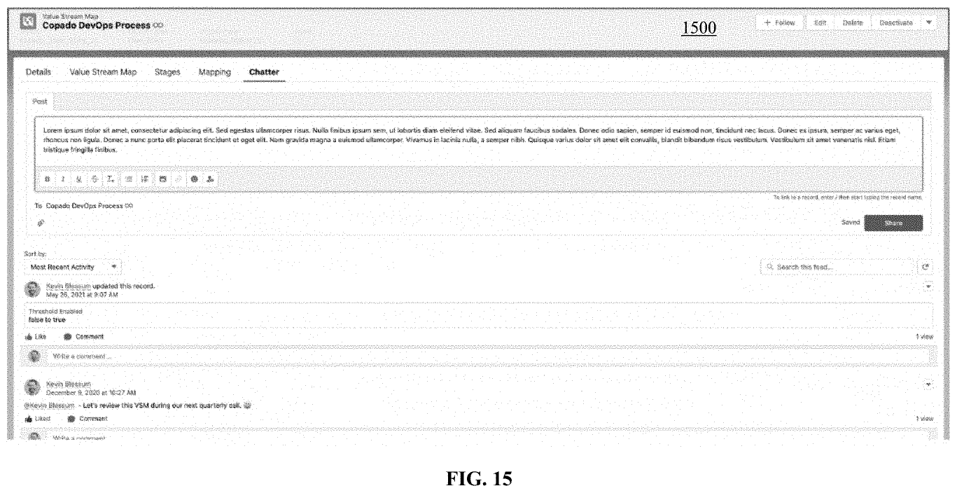

Additionally, users in some examples can view and access underlying records related to a VSM. Referring to FIG. 14, a screenshot 1400 of exemplary underlying records in a VSM is illustrated. In this example, each component within the VSM 1200 is selectable and can show the user underlying records. The underlying records are displayed in a table format and include hyperlinks so that the user can click on the work item to take action, if desired. The count of workers acting on the work items can also be displayed on all of the active and waiting stages.

A VSM in some examples of this technology also facilitates collaboration on particular records. Referring to FIG. 15, an exemplary screenshot 1500 of an integrated chat application is illustrated. Those who can participate in a conversation include users who are in the system of record. Users can have text conversations on a VSM and reference any attributes to the VSM in the text conversation, for example, and other types of collaboration can also be facilitated with this technology.

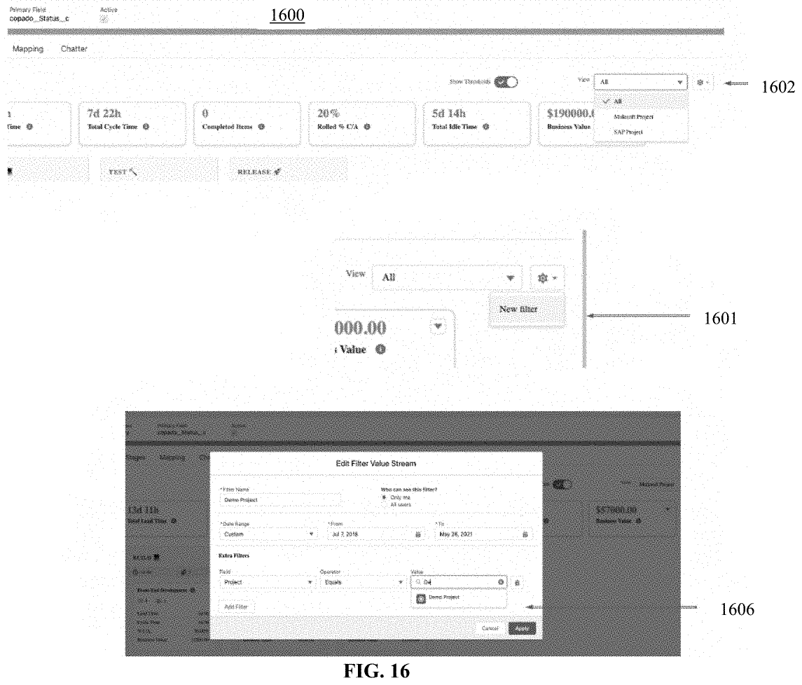

A VSM also can be filtered by users to show only a subset of data. Filters can be created, configured, and displayed on the VSM to allow users to quickly change the filters. Records can be filtered based on data range. In addition, any field on the object used to store the work items can be used as filter criteria. Referring to FIG. 16, an exemplary filter interface 1600 is illustrated. The filter interface 1600 for creating filters obtains the available list of fields from the database schema and displays a window to allow users to apply the filter. In the example illustrated in FIG. 16, a dropdown menu 1602 facilitates selection of a new filter indication 1604, which generates a filter overlay 1606 that includes a plurality of filter input fields. The application server 104 is configured to recalculate all of the metrics associated with a VSM based on the subset of event records that meet the filter criteria upon application of a filter.

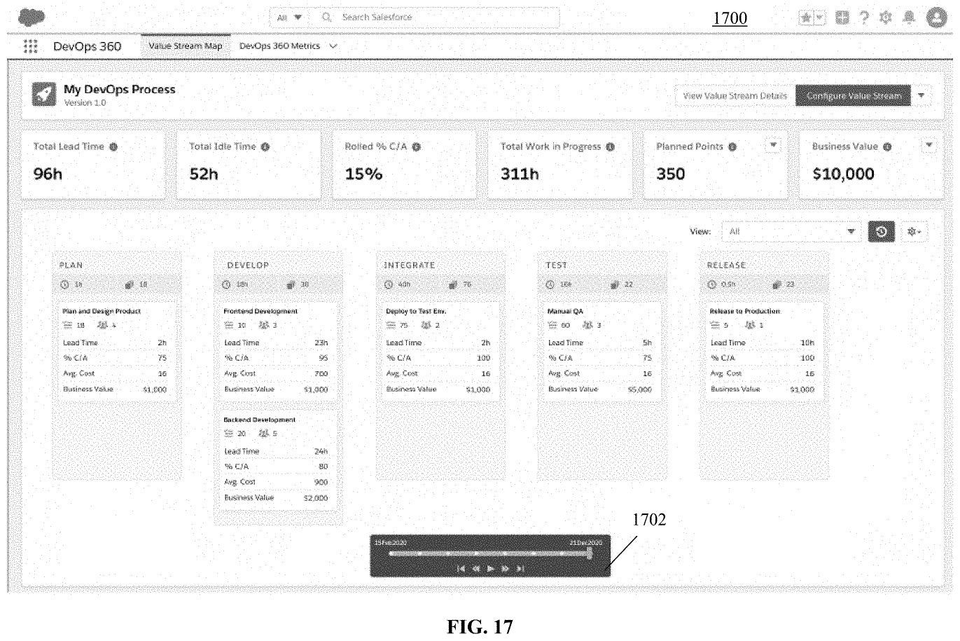

Optionally, the VSM of this technology can include a timeline feature that allows users to enable a particular filter as a data timeline filter so that users can filter a specific time window for snapshot capabilities. Referring to FIG. 17, a an exemplary timelines interface 1700 is illustrated. Data filters can be input via a filter overlay (e.g., filter overlay 1606 of FIG. 16) allowing a user can go back in time to compare snapshots of data on a VSM as shown in FIG. 17. A slider 1702 is displayed to allow quick filtering to a specific time window. Upon receiving an interaction with the slider 1702, the application server can update the displayed VSM to include relevant metrics related to that time window based on a recalculation and/or retrieval of metric data from the event summaries stored as snapshots in step 1012.

Additionally, the VSM of this technology optionally facilitates a visual indication of individual stages and process blocks based on configured thresholds. Thresholds can be configured for any metric for a stage including the number of work items and idle time. Once configured, thresholds can optionally be hidden with a toggle feature. Thresholds can also be configured for any metric displayed for a process block including the number of work Items, the number of operators, lead time, cycle time, percentage complete and accurate, and custom metrics. Thresholds can support numeric values and can be triggered if values fall lower or higher than any particular metric.

Further, the application server 104 can facilitate tracking of statistically significant increases or decreases in trends based on a threshold that is set. Once a threshold is configured, a VSM can track the trend of the metric and display it to the user as a positive or negative trend. The trends are highlighted on a VSM using the threshold colors, for example. Even further, the VSM can be configured to automatically send notifications in the form of notifications to a chat client or email, for example, based on a threshold that is exceeded and stored preferences or contact information.

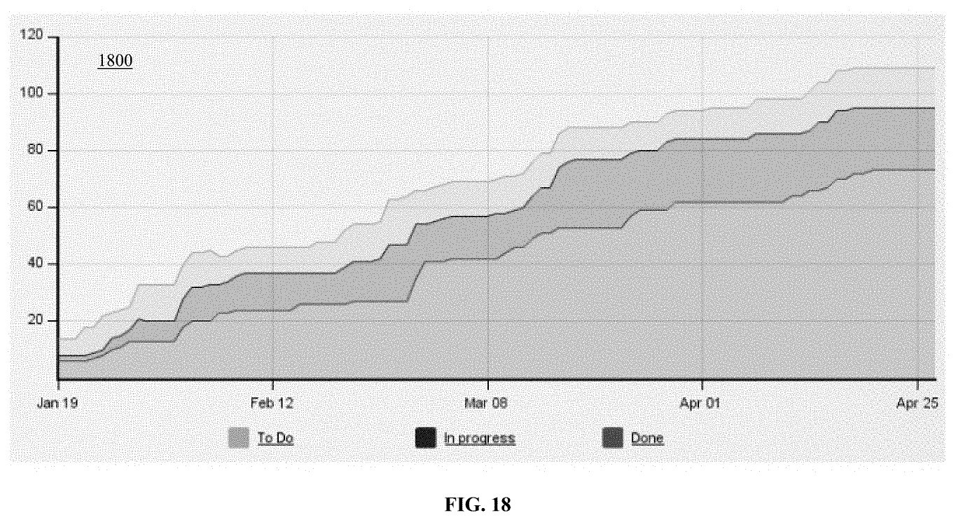

VSM events can be utilized by the application server 104 to display graphs of any type to show a progression over time by stage. One visualization that summarizes the movement of work over time is a cumulative flow graph, which is a stacked area chart. Referring to FIG. 18, an exemplary cumulative flow graph 1800 is illustrated. In the cumulative flow graph 1800, the horizontal (x) axis represents time and the vertical (y) axis represents the number of work items in various statuses over time. The height of the lower layer of the cumulative flow graph 1800 corresponds to the number of work items that have one of the completed statuses at that point in time. The height of the next layer of the cumulative flow graph 1800 corresponds to the number of work items in the right-most stage in the VSM. Each subsequent layer in the cumulative flow graph 1800 is calculated in the same way, totaling the remaining stages from right to left. The raw data for these calculations is stored alongside the snapshots described and illustrated above. Each row in the data table represents one unit of time (e.g., one day). The heights of each subsequent stage, along with the ID of that stage, are stored as numbered columns in a table, allowing for an arbitrary number of stages to be tracked in a compact data format.

Referring back to FIG. 3, subsequent to generating and displaying a VSM in this example, the application server proceeds back to step 302. In other examples, one or more of the steps illustrated in steps 3-4 and 10 can be performed by the application server 104 in a different order and/or in parallel with one or more other of the steps. Accordingly, the application server 104 is continuously or periodically collecting and processing change data to facilitate presentation of a user interface including a VSM upon request.

The VSM provided with this technology includes an optimized graphical layout with a rich set of metrics facilitated based on an underlying format and particular processing of change data obtained via an enterprise application platform. Accordingly, as described and illustrated herein, this technology tracks electronic processes carried out on enterprise application or cloud platforms more effectively, and generates VSMs that include a robust set of data and metrics and varying levels of granularity to allow users to gain insights regarding stages and sub-processes to facilitate optimization of the associated overall tracked process.

Having thus described the basic concept of the technology, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the technology. Additionally, the recited order of processing elements or sequences, or the use of numbers, letters, or other designations therefore, is not intended to limit the claimed processes to any order except as may be specified in the claims. Accordingly, the technology is limited only by the following claims and equivalents thereto.

What is claimed is:

1. A system for value stream mapping, the system comprising:
a memory configured to store a value stream map (VSM) model for a process, the VSM model comprising a sequence of active stages for a plurality of items of the process, wherein each active stage is associated with one or more status values attributable to the items; and
a processor for cooperation with the memory, the processor configured to (1) access a time series of status change data about a plurality of items for the process, wherein the status change data comprises a plurality of status values exhibited by the items over time and (2) transform the accessed time series of status change data into a VSM based on a correlation between (i) the status values exhibited by the items from the accessed time series of change data and (ii) the status values associated with the active stages of the VSM model.

2. The system of claim 1 wherein the VSM model is customizable by a user to represent any of a plurality of different processes in response to user input through one or more graphical user interfaces (GUIs).

3. The system of claim 2 wherein the processor is further configured to define the VSM model in response to user input through the one or more GUIs, wherein the one or more GUIs are configured to receive user input that (1) defines the sequence of active stages and (2) assigns status values attributable to items of the active stages so that each active stage is mapped to one or more of the status values attributable to the items.

4. The system of claim 3 wherein the user input that defines the sequence of active stages comprises (1) user input that identifies names for the active stages and (2) user input that identifies an ordering relationship for the active stages within the sequence.

5. The system of claim 3 wherein the one or more GUIs are further configured to receive user input that (1) identifies a set of records for the items of the process and (2) identifies a status field of the records where the status values attributable to the items are found, and wherein the processor is further configured to determine the available status values for assignment to the active stages based on the identified status field.

6. The system of claim 3 wherein each active stage comprises one or more process blocks, wherein each process block is associated with one or more status values attributable to the items, and wherein the processor is further configured to transform the accessed time series of status change data into the VSM based on a correlation between (i) the status values exhibited by the items from the accessed time series of change data and (ii) the status values associated with the process blocks of the VSM model.

7. The system of claim 1 wherein the processor is further configured to define a plurality of different VSM models for a plurality of different processes in response to user input through one or more graphical user interfaces (GUIs) to create a library of different VSM models for producing VSMs relating to the different processes.

8. The system of claim 1 wherein the processor is further configured to compute a plurality of metric values for the process based on a plurality of metrics, wherein the VSM includes a plurality of the computed metric values.

9. The system of claim 8 wherein the metrics include one or more of (1) an idle time metric for the items, (2) a cycle time metric for the items, (3) a lead time metric for the items, and/or (4) a quality metric for the items.

10. The system of claim 8 wherein the metrics values include a count of items within each active stage based on the correlation.

11. The system of claim 8 wherein the processor is further configured to (1) compute a plurality of item-specific metric values and (2) aggregate the computed item-specific metric values to stage-specific metric values based on the correlation.

12. The system of claim 8 wherein each active stage comprises one or more process blocks, wherein each process block is associated with one or more status values attributable to the items, and wherein the processor is further configured to (1) transform the accessed time series of status change data into the VSM based on a correlation between (i) the status values exhibited by the items from the accessed time series of change data and (ii) the status values associated with the process blocks of the VSM model. (2) compute a plurality of item-specific metric values, and (3) aggregate the computed item-specific metric values to process block-specific metric values based on the correlation.

13. The system of claim 8 wherein the metrics include a plurality of metrics that are customizable in response to user input through one or more graphical user interfaces (GUIs).

14. The system of claim 8 wherein the processor is further configured to associate the items with a plurality of metric values for different metrics applicable to the items during the active stages through which the items passed.

15. The system of claim 1 wherein the processor is further configured to (1) access a database table or an object that comprises a history of changes to states for the items and (2) generate the time series of status change data based on the accessed database table or object.

16. The system of claim 15 wherein the history comprises a plurality of records about the items, wherein each record includes (i) an identifier field that comprises an identifier for the item applicable to that record, (ii) a status field that comprises a status value attributable to the item applicable to that record, and (iii) a time field that comprises a time stamp applicable to the status value in the status field.

17. The system of claim 1 wherein the processor is further configured to (1) access a database table or an object that comprises a history of executed activity processes related to the items and (2) generate the time series of status change data based on the accessed database table or object.

18. The system of claim 17 wherein the history comprises a plurality of records about the activity processes, wherein each record includes (i) an identifier field that comprises an identifier for the item applicable to that record, (ii) an identifier field that identifies the activity process applicable to that record, (iii) one or more time fields that comprise data indicative of a time period corresponding to the activity process applicable to that record, and (iv) a field that comprises data indicative of a result for the activity process applicable to that record; and
wherein the processor is configured to translate the fields of the activity process records to the time series of status change data based on a defined relationship between fields of the activity process records and fields of the time series of status change data.

19. The system of claim 1 wherein the processor is further configured to (1) process the time series of status change data to determine, for each of plurality of the items, re-entry data indicative of how many times the item was returned to an earlier active stage in the sequence when passing through the active stages and (2) associate the items with their determined re-entry data as applicable as a quality metric.

20. The system of claim 1 wherein each active stage comprises one or more process blocks, wherein each process block is associated with one or more status values attributable to the items, and wherein the processor is further configured to transform the accessed time series of status change data into the VSM based on a correlation between (i) the status values exhibited by the items from the accessed time series of change data and (ii) the status values associated with the process blocks of the VSM model.

21. The system of claim 20 wherein each of a plurality of the stages includes a process block that corresponds to a waiting stage.

22. The system of claim 1 wherein the processor is further configured to generate a timeline of a plurality of VSMs based on a plurality of snapshots of different VSMs generated from the accessed time series of change data over time.

23. The system of claim 1 wherein the processor is further configured to display a visualization of the VSM via one or more graphical user interfaces (GUIs).

24. The system of claim 1 wherein the processor comprises a plurality of processors.

25. The system of claim 24 wherein the processors comprise a first processor configured to transform the accessed time series of change data into the VSM and a second processor configured to display a visualization of the VSM to a user via one or more graphical user interfaces (GUIs).

26. The system of claim 24 wherein the processors comprise a first processor resident in a server and a second processor resident in a client device, wherein the first processor is further configured to provide the time series of status change data to the second processor, and wherein the second processor is configured to (1) transform the accessed time series of status change data into the VSM and (2) cause the client device to display the VSM.

27. The system of claim 26 wherein the second processor is further configured to provide progressive loading and display of the VSM on a stage-specific or a process block-specific basis.

28. The system of claim 1 wherein the VSM model further comprises a backlog stage, a canceled stage, and a completed stage for the items of the process.

29. The system of claim 1 wherein the process corresponds to a software development process, and wherein the items comprise work items relating to the software development process.

30. The system of claim 1 wherein the process corresponds to a customer support process, and wherein the items comprise work items relating to the customer support process.

31. The system of claim 1 wherein the process corresponds to a sales process, and wherein the items comprise work items relating to the sales process.

32. A computer program product for value stream mapping, the computer program comprising:
a plurality of instructions that are resident on a non-transitory computer-readable storage medium, the instructions configured for execution by a processor to cause the processor to:
access a value stream map (VSM) model for a process, the VSM model comprising a sequence of active stages for a plurality of items of the process, wherein each active stage is associated with one or more status values attributable to the items; and
access a time series of status change data about a plurality of items for the process, wherein the status change data comprises a plurality of status values exhibited by the items over time; and
transform the accessed time series of status change data into a VSM based on a correlation between (i) the status values exhibited by the items from the accessed time series of change data and (ii) the status values associated with the active stages of the accessed VSM model.

33. A method for value stream mapping, the method comprising:
a processor accessing a value stream map (VSM) model for a process, the VSM model comprising a sequence of active stages for a plurality of items of the process, wherein each active stage is associated with one or more status values attributable to the items; and
the processor accessing a time series of status change data about a plurality of items for the process, wherein the status change data comprises a plurality of status values exhibited by the items over time; and
the processor transforming the accessed time series of status change data into a VSM based on a correlation between (i) the status values exhibited by the items from the accessed time series of change data and (ii) the status values associated with the active stages of the accessed VSM model.

34. The method of claim 33 wherein the processor comprises a plurality of processors.
